(19) United States
(12) Patent Application Publication
(10) Pub. No.: US 2025/0371932 A1
(43) Pub. Date: Dec. 4, 2025

(54) GAMING DEVICE MANAGEMENT ACROSS DIFFERENT GAMING DEVICE CONTROLLERS

(71) Applicant: IGT, Las Vegas, NV (US)

(72) Inventors: Dwayne NELSON, Las Vegas, NV (US); Kevin HIGGINS, Reno, NV (US)

(73) Assignee: IGT, Las Vegas, NV (US)

(21) Appl. No.: 18/677,289

(22) Filed: May 29, 2024

(51) Int. Cl. G07F 17/32

(52) U.S. Cl. CPC G07F 17/3227; G07F 17/3258; G07F 17/3269

(57) ABSTRACT

A processor circuit determines a downtime period for a first gaming device controller in communication with a plurality of gaming devices. A first controller configuration of the first gaming device controller for providing a controller service to the plurality of gaming devices is determined. Before the downtime period, a second gaming device controller is provisioned with a second controller configuration corresponding to the first controller configuration for providing the service to the plurality of gaming devices. The second gaming device controller provides the service to the plurality of gaming devices.

### BACKGROUND

Embodiments described herein relate to gaming device controllers, and in particular to gaming device management across different gaming device controllers, and related devices, systems, and methods. In some conventional gaming device control configurations, a plurality of induvial gaming devices, such as Electronic Gaming Machines (EGMs) may be connected to and controlled by a gaming device controller, such as a bank controller and/or a progressive controller, which may provide game features and other features and functionality to the EGMs. In some conventional configurations, if the gaming device controller fails, the connected EGMs will also enter a failure state (sometimes referred to as a tilt), because the EGMs are unable to obtain current data, such as a current progressive award, to provide connected features to the player and/or to coordinate with other EGMs, such as to inform the other EGMs that a progressive award has been won. There is a need for a gaming device management configuration that enables connected EGMs to remain active even if a connected gaming controller is offline.

### BRIEF SUMMARY

According to some embodiments, a system includes a processor circuit and a memory coupled to the processor circuit. The memory includes machine-readable instructions that, when executed by the processor circuit, cause the processor circuit to determine a downtime period for a first gaming device controller in communication with a plurality of gaming devices. The instructions further cause the processor circuit to determine a first controller configuration of the first gaming device controller for providing a controller service to the plurality of gaming devices. The instructions further cause the processor circuit to, before the downtime period, provision a second gaming device controller with a second controller configuration corresponding to the first controller configuration for providing the service to the plurality of gaming devices. The instructions further cause the processor circuit to cause the second gaming device controller to provide the service to the plurality of gaming devices.

According to some embodiments, a gaming device controller includes a communication interface in communication with a plurality of gaming devices, a processor circuit and a memory coupled to the processor circuit. The memory includes machine-readable instructions that, when executed by the processor circuit, cause the processor circuit to determine a downtime period for the gaming device. The instructions further cause the processor circuit to determine a first controller configuration for providing a controller service to the plurality of gaming devices. The instructions further cause the processor circuit to, before the downtime period, provision a second gaming device controller with a second controller configuration corresponding to the first controller configuration for providing the service to the plurality of gaming devices. The instructions further cause the processor circuit to instruct the second gaming device controller to provide the service to the plurality of gaming devices.

According to some embodiments, a method includes determining, by a processor circuit, a downtime period for a first gaming device controller in communication with a plurality of gaming devices. The method further includes determining, by the processor circuit, a first controller configuration of the first gaming device controller for providing a controller service to the plurality of gaming devices. The method further includes, before the downtime period, provisioning, by the processor circuit, a second gaming device controller with a second controller configuration corresponding to the first controller configuration for providing the service to the plurality of gaming devices. The method further includes causing, by the processor circuit, the second gaming device controller to provide the service to the plurality of gaming devices.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 illustrates a communication diagram for gaming device controllers and EGMs for providing gaming device management across different controllers, according to some embodiments.

FIG. 4 illustrates a communication diagram for a service host and management host for configuring gaming device controllers and/or EGMs, according to some embodiments.

FIG. 5 illustrates a communication diagram for a management host, gaming device controller, and EGMs to manage the EGMs during a controller downtime event, according to some embodiments.

FIG. 6 is a flowchart illustrating operations of systems/methods of providing gaming device management across different controllers, according to some embodiments.

### DETAILED DESCRIPTION

Embodiments described herein relate to gaming device controllers, and in particular to gaming device management across different gaming device controllers, and related devices, systems, and methods. In some examples, a system may respond to a predictive maintenance or scheduled maintenance event by reconfiguring connected devices before the service or failure, to avoid a disruption of service for the other devices. One technical advantage of these and other arrangements is that the overall gaming system may remain operational during service events, thereby allowing for more flexible service scheduling without interrupting gaming operations.

In some examples, the system may predict a problem with a controller or other device and may adjust the system configuration to avoid disruption of other devices in the system. The system can remain in the new configuration or adjust back to the original configuration after a repair action. Unlike many conventional systems, which typically schedule maintenance operations during periods of low occupancy in a casino, these and other examples allow for the servicing of gaming equipment even during busy hours of a casino.

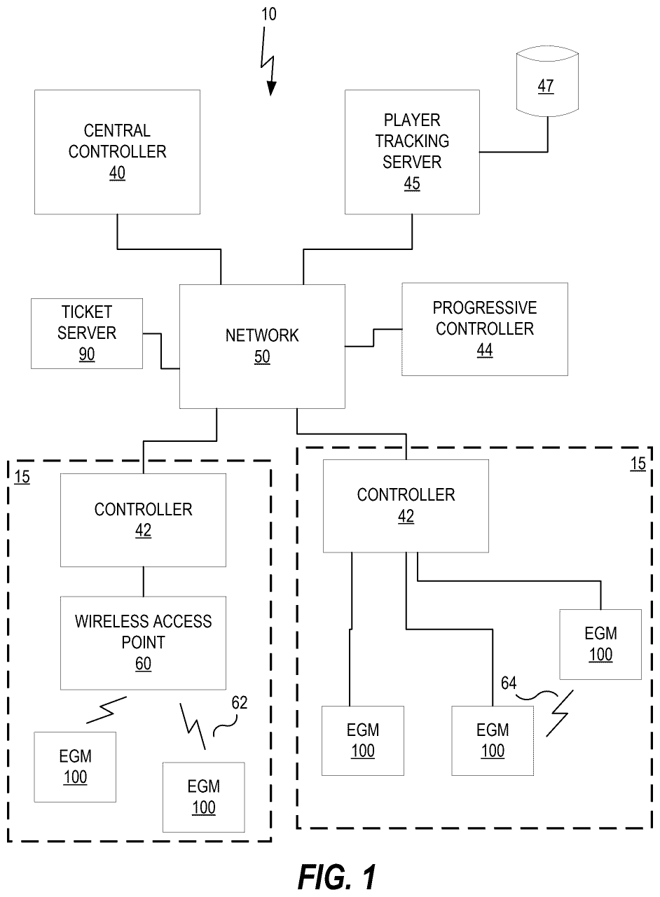

Before describing these and other features in greater detail, reference is now made to FIG. 1, which illustrates a gaming system 10 including a plurality of gaming devices 100 (which are EGMs in this embodiment). The gaming devices 100 may be one type of a variety of different types of gaming devices, such as electronic gaming machines (EGMs), video lottery terminals (VLTs), mobile gaming devices, or other devices, for example. The gaming system 10 may be located, for example, on the premises of a gaming establishment, such as a casino, and/or distributed across one or more different locations 15, such as a plurality of banks of gaming devices in a casino or other establishment, and/or a plurality of retailers or other establishments. The gaming devices 100 may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. Each location 15 may include a site controller 42 for managing communication with the central controller 40 and for controlling and managing the gaming devices 100. The central controller 40 and/or site controller 42 may be any suitable server or computing device which includes at least one processing circuit and at least one memory or storage device. Each gaming device 100 (which are EGMs in this example) may include a processing circuit that transmits and receives events, messages, commands or any other suitable data or signal between the gaming device 100, the site controller 42, and/or the central controller 40. The gaming device processing circuit is operable to execute such communicated events, messages or commands in conjunction with the operation of the gaming device 100. Moreover, the processing circuit of the and/or site controller 42 is configured to transmit and receive events, messages, commands or any other suitable data or signal between the central controller 40, the site controller 42, and/or each of the individual gaming devices 100. In some embodiments, one or more of the functions of the central controller 40 and/or site controller 42 may be performed by one or more gaming device processing circuits. Moreover, in some embodiments, one or more of the functions of one or more gaming device processing circuits as disclosed herein may be performed by the central controller 40 and/or site controller 42.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 and/or site controller 42 through the data communication network 50. The ticket server 90 may be located remotely from the individual locations 15 and/or site controllers 42 and/or may be located at individual locations 15 and/or proximate to individual site controllers 42. In some examples, the ticket server 90 and/or functions thereof may be integrated into the central controller 40 and/or local controllers 42. Each ticket server 90 may include a processing circuit that transmits and receives events, messages, commands or any other suitable data or signal between the ticket server 90 and the central controller 40 and/or local controller 42. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40 and/or local controller 42. In some embodiments, a progressive controller 44 may be in communication with the gaming devices 100 via one or more communication protocols, such as eIPP, SAS, etc., based on the communication capabilities of the respective gaming devices 100.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. Some embodiments provide that gaming devices 100 may communicate with other gaming devices 100 or other system components over a wireless interface 64. In these embodiments, wireless interface 62, and wireless interface 64 may use different communication protocols and/or different communication resources, such as different frequencies, time slots, spreading codes, etc.

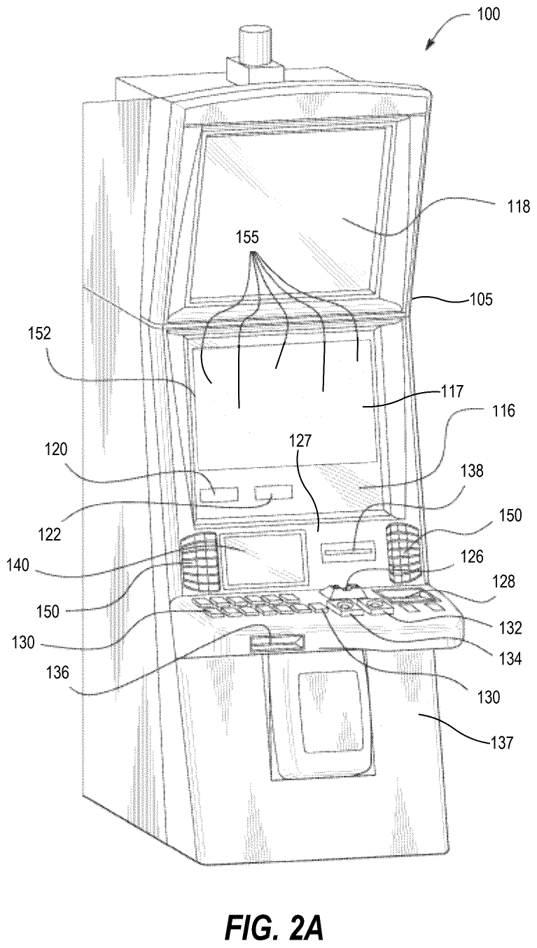

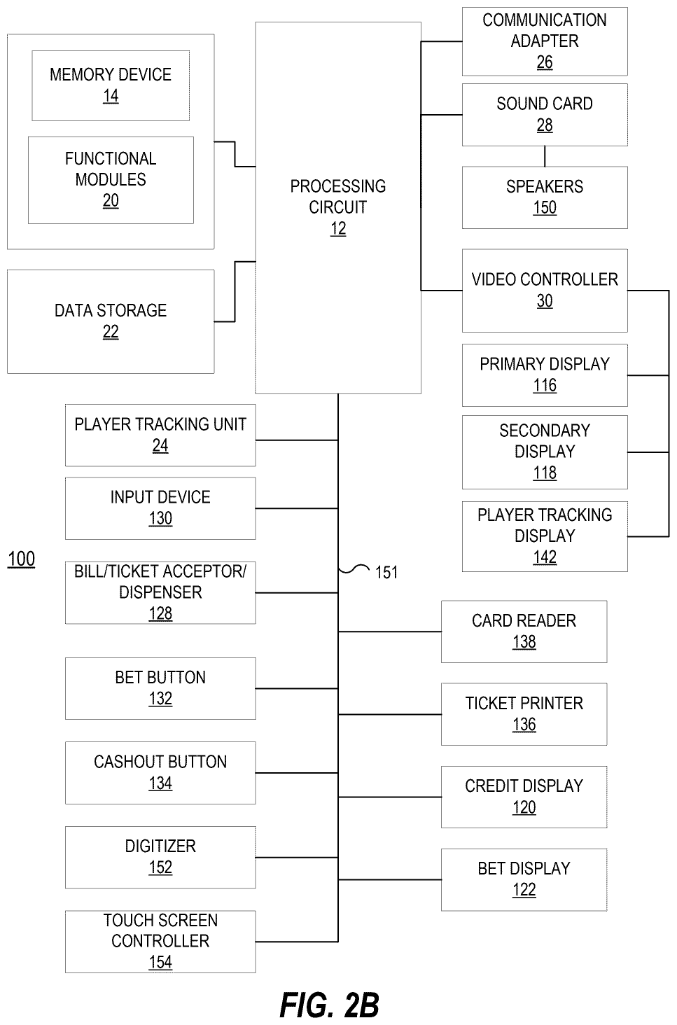

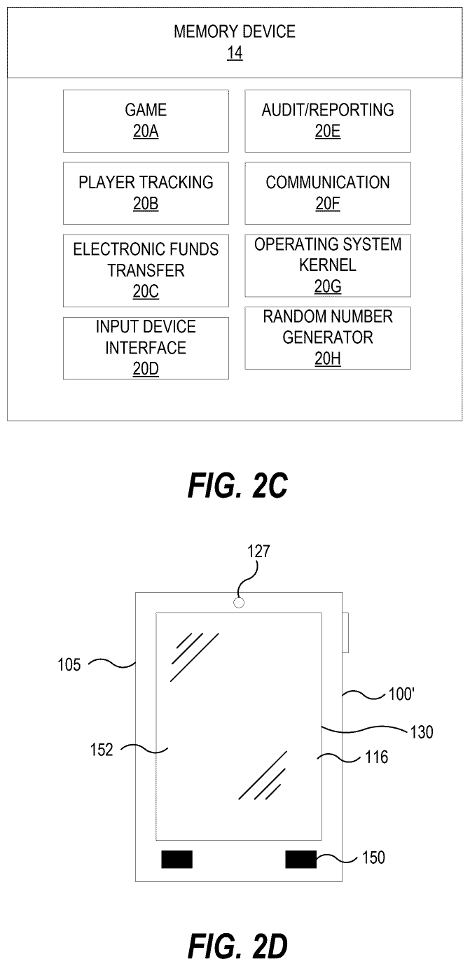

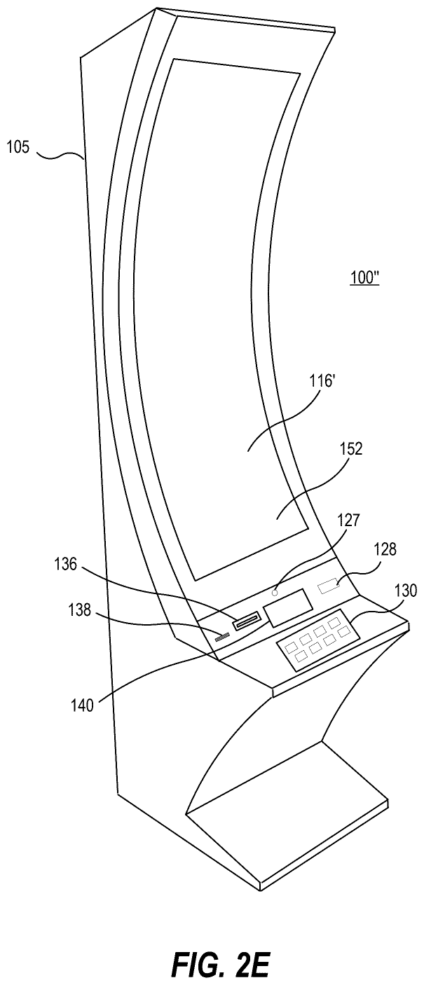

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIG. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as EGMs, VLTs, and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino, lottery, or other style games. Further, gaming devices according to embodiments herein may be implemented using other computing devices and mobile devices, such as smart phones, tablets, and/or personal computers, among others.

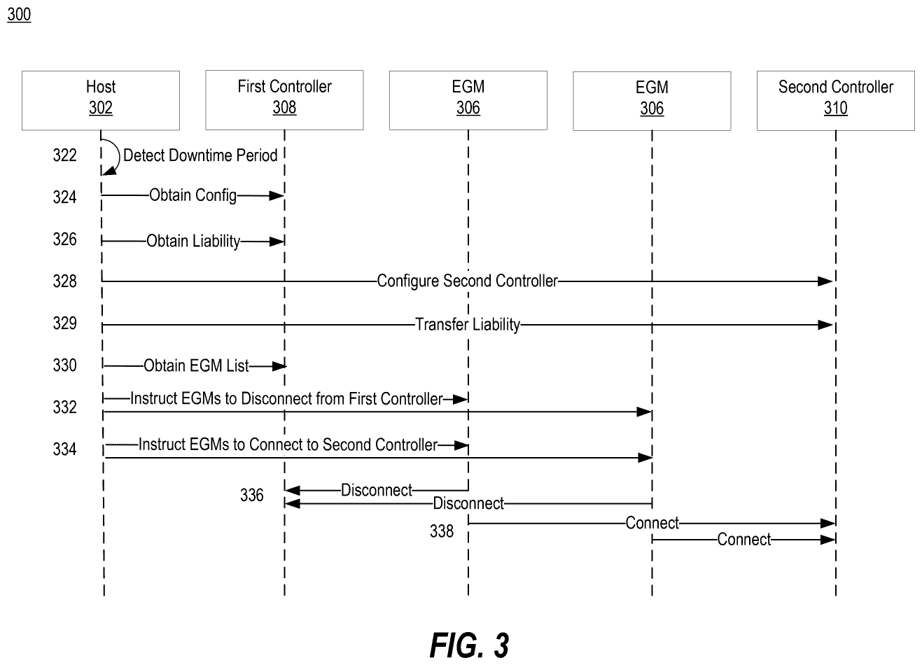

FIG. 3 illustrates a communication diagram 300 for gaming device controllers 304 and EGMs 306 for providing gaming device management across different controllers, according to some embodiments. As discussed above, if a first gaming device controller 308, such as a bank controller for a progressive, fails, the connected EGMs 306 would normally be unable to continue offering the progressive, because the EGMs 306 would not be able to access a current progressive jackpot value or communicate with other EGMs 306 in the event of a progressive jackpot win.

In this example, a host 302 detects a downtime period for the first gaming device controller 308 (322), such as a failure state, a scheduled maintenance event, or other condition indicative of current or upcoming downtime for the first gaming device controller 308. The host 302 may communicate with the first gaming device controller 308 to obtain a controller configuration (324). The configuration may include the progressive configuration, themes, regulatory limits and operator configuration of the controller and/or the progressive pool, etc. Progressive configurations may include a number of progressive levels, each level's contribution rate, each level's current amount, each level's reset amount, and/or any other information needed for the operation of the progressive pool. In one embodiment, the host 302 may already know the configuration of the first gaming device controller 308 before the detecting the downtime period, and would not need to query the first gaming device controller 308. The host 302 may also obtain a current liability for the controller (326). The liability may include an amount of funds stored in the pool and/or the controller, and/or each level.

The host 302 may now configure a second gaming device controller 310 (328) with the same or equivalent configuration, and may move the liability removed from the first gaming device controller 308 to the second gaming device controller 310 (329). In some examples, the host 302 may match the exact liability per level, but in other embodiments the host 302 might take the opportunity to adjust the liability per level.

The host next obtains a list of connected EGMs 306 from the first gaming device controller 308 (330). In some examples, the host 302 may have this information before detecting the downtime period. The host 302 next instructs each connected EGM 306 to disconnect from the first gaming device controller 308 (332) and to connect to the second gaming device controller 310 (334). Each EGM 306 then disconnects from the first gaming device controller 308 (336) and connects to the second gaming device controller 310 (338).

In some examples, the host 302 may first disconnect and configure the EGMs 306 before retrieving the liability, which may prevent the EGMs 306 from contributing to the first gaming device controller 308 during the time period between retrieving the liability from the first gaming device controller 308 and disconnecting the EGMs 306 from the first gaming device controller 308, which may in turn result in the second gaming device controller 310 not obtaining the most recent liability values. In some examples, the delay between these operations may only be a few seconds, which may be short enough to avoid significant disruption in the operation of the EGMs 306 during the transition period.

In some examples, the configuration of the second gaming device controller 310 may include instructions for communicating with signage, such as a network address, credentials, certificates, etc. for communication with a sign controller. The second gaming device controller 310 may be responsible for connecting directly to the enrolled signs. In some examples, the signs may be responsible for communicating with the second gaming device controller 310, in which case the second gaming device controller 310 may require credentials or other sign enrollment information in order to only allow enrolled signs to communicate with the second gaming device controller 310.

In some embodiments, a bank controller may a sign display (e.g., monitor or television) directly, or may communicate with a separate device that renders and displays the sign content. In some embodiments, the configuration of the second gaming device controller 310 may further include information about the content to display, such as what sounds and how to play them (such as volumes), localization information such as the local currency and language, etc.

In some examples, the host 302 may instruct the second gaming device controller 310 to download software from the host 302 or other connected device before configuring. For example, the host 302 may obtain a list of software packages installed on the first gaming device controller 308 and may cause those packages or equivalent packages to be installed on the second gaming device controller 310 using protocols such as HTTP, FTP, G2S, etc. Software packages may include an operating system, controller platform software, progressive software, sign content software, etc.

As discussed above, the liability may be transferred to the second gaming device controller 310 entirely, or could be distributed in a different manner, as desired. For example, the second gaming device controller 310 may have the same total liability as the first gaming device controller 308, but the liability may be distributed differently per level. In another embodiment, some or all of the liability of the first gaming device controller 308 is moved to a third controller. For example, the liability of the first gaming device controller 308 could be moved to a system mystery bonus (i.e., mystery progressive) based on the a configuration for the host 302 and/or operator. Alternatively, some amount of the liability from the first gaming device controller 308 less than the full amount could be transferred to the second gaming device controller 310, with the remaining amount being transferred to one or more other controllers, and/or held until a later point in time (such as when the casino is busy, etc.), as desired.

In some examples, the host 302 can include or add liability to one or more progressive configurations based upon previously gathered liability (such as from the previous day, etc.), in order to minimize the amount of non-deployed or non-active player progressive liability funds held by the host 302. For example, in certain jurisdictions, the host 302 may have a requirement to hold a liability amount for no longer than ten days. In some embodiments, this could result in the host 302 adjusting progressive liability across one or more connected devices independent of a repair triggering event in order to meet these jurisdictional requirements.

In some embodiments the EGMs 306 may remain connected to the second gaming device controller 310 even after the end of the downtime period for the first gaming device controller 308. For example, in a cloud-based system, the physical proximity of controllers to their respective EGMs may be less important. In some cloud-based systems, a host may start a new controller as a Virtual Machine (VM) or cloud service rather than provision a new hardware device.

In some examples, an EGM may include a built-in progressive controller such that the EGM can replace the progressive features of a bank controller. In some examples, the host 302 may move the progressive functions to one or more EGMs 306 in the EGM bank, adjacent banks, etc. In some embodiments, the host 302 may move the progressive between a bank controller and an embedded EGM controller. In some embodiments, a sign configuration may not move to the embedded EGM controller, and the signage may not display content during the servicing period if the embedded EGM controller does not support signage or other features. In some embodiments, the host 302 may only choose the embedded EGM controller if no signage is needed or when the embedded EGM controller is already in use, as desired.

It should be appreciated that any service the EGMs or controllers are running might trigger a detectable event indicating a downtime period. For example, an EGM that is running gaming platform software, games, and a progressive controller, may disrupt service for all three even if only one service is malfunctioning or needs maintenance.

Predictive events that may cause the detection of a downtime period may include an event indicating wear of a device, such as an SSD lifetime indicator, device warning or errors (device write failures, device read failures, etc.), temperatures rising or changes unexpectedly, CPU, GPU, cabinet or other temperature alerts, fans changing speed (e.g., slowing down) unexpectedly, such as cabinet, CPU or GPU fans, an amount of time the product and/or device is in use, an amount of memory in use by the device and changes in memory usage, an amount of CPU utilization by the device and changes in CPU utilization, an amount of energy used by the product or device, etc., a scheduled service or repair event, a scheduled installation of new or updated software or hardware components, a manual request from a technician or casino staff member (such as a service support call that reports a device is malfunctioning for example), a communication failures with peripheral devices, and/or a security check of the device, or peripheral devices fails. In some examples, machine learning and/or artificial intelligence analysis of game or machine events may create or trigger a predictive event.

In some examples, the host 302 may schedule a service or wait for the device to fail, and/or may take the device offline immediately, based on a number of factors, including severity of the problem, expected failure time, etc. In some embodiments, a service or repair request may entered into the system, e.g., manually by a person or automatically based on analysis of game events or conditions, such as a scheduled update for a hardware component of the first gaming device controller 308. This triggers the host 302 to move the progressives off the first gaming device controller 308 to the second gaming device controller 310.

In some examples, the controllers may include Ticket-In Ticket Out (TITO) ticketing controllers. In some configurations, if the TITO controller experiences downtime, the connected EGMs would output errors and be unusable. In one embodiment, the Host configures the EGMs 306 to use an alternate ticketing host, or to use no ticketing host (e.g., configuring the EGM to only accept cash, wallet or EFT transfers, etc., but not tickets, and to only dispense coins or perform transfers back to a cashless wagering account or wallet).

In some examples, the operator may be prompted with options for how to reconfigure the devices, such as a choice between disabling the games and converting them to non-progressive games.

In some examples, a downtime period for a first gaming device controller 308 in communication with a plurality of gaming devices 306 is determined. A first controller configuration of the first gaming device controller 308 for providing a controller service to the plurality of gaming devices is determined. Before the downtime period, a second gaming device controller 310 is provisioned with a second controller configuration corresponding to the first controller configuration for providing the service to the plurality of gaming devices 306. The second gaming device controller 310 then provides the service to the plurality of gaming devices 306.

In some examples, the first gaming device controller 308 may then stop provision of the service to the plurality of gaming devices 306. After a determination that the downtime period for the first gaming device controller 308 has ended, the first gaming device controller 308 may resume provision of the service to the plurality of gaming devices 306, and the second gaming device controller 310 may stop provision of the service to the plurality of gaming devices 306. In some examples, causing the first gaming device controller310 to stop provision of the service to the plurality of gaming devices 306 may occur before or after causing the second gaming device controller 310 to provide the service to the plurality of gaming devices 306, as desired.

In some examples, the first gaming device controller 308 may be a first bank controller and the plurality of gaming devices 306 may be EGMs proximate to the first bank controller, and the second gaming device controller 310 may be a second bank controller.

In some examples, the service may include a progressive wagering game service for provision of a progressive wagering game at the plurality of gaming devices 306. In some examples, provisioning the second gaming device controller 310 with the second controller configuration may further include transferring a liability from the first gaming device controller 308 to the second gaming device controller 310.

In some examples, the first gaming device controller 308 may be a first Ticket-In/Ticket-Out (TITO) controller and the plurality of gaming devices 306 may be EGMs proximate to the first TITO controller, and the second gaming device controller 310 may be a second TITO controller. In some examples, the second gaming device controller 310 may include a first gaming device of the plurality of gaming devices 306. In some examples, the second gaming device controller 310 may also be in communication with a second plurality of gaming devices to provide the service to the second plurality of gaming devices.

In some examples, the determination of the downtime period for the first gaming device controller 308 may be based on a scheduled downtime period for the first gaming device controller 308, detection of a security breach at the first gaming device controller 308, and/or an operator interaction with the first gaming device controller 308.

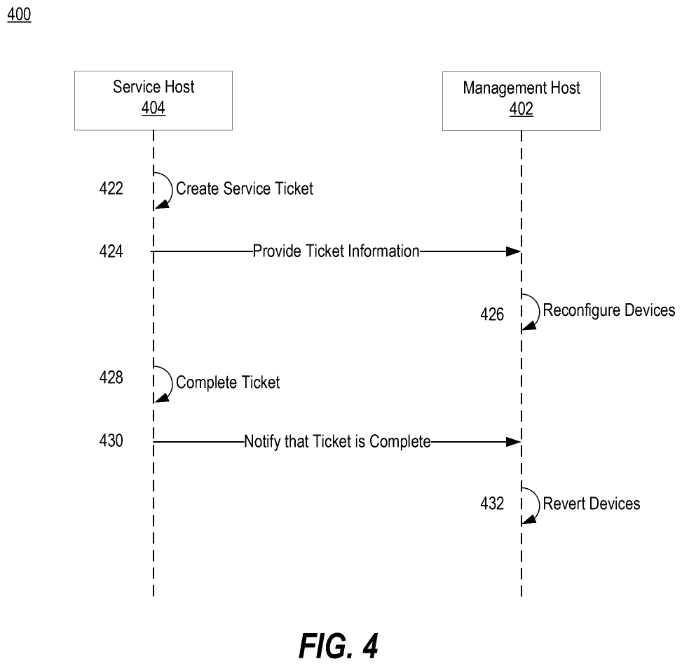

FIG. 4 illustrates a communication diagram 400 for a service host 412 and management host 402 for configuring gaming device controllers and/or EGMs, according to some embodiments. In this example, the service host 412 creates a service ticket (422) to perform some service on some gaming equipment, such as a controller, EGM, etc. The ticket created may have a date and time of the service to be completed, the service to complete and the affected devices. The service host 412 provides the ticket information is provided to the management host 402 (424). The management host 402 performs configurations on eligible connected devices (426), based on a scheduled service date and time, immediately, or based on certain conditions, such as time of day, device utilization, etc. For example, if the ticket indicates that a bank controller fan must be replaced on a Monday, the management host 402 might reconfigure the controller and/or associated EGMs the Sunday evening before. When the ticket is complete (428), the service host 412 notifies the management host 402 (430), which then may revert the device(s) to its previous configuration (432).

In some examples, the service host 412 may inform the management host 402 of the affected devices based on the service ticket. The management host 402 may determine an expanded pool of affected devices based on stored device information relating to connectivity and types of the devices that are in communications with one or more affected devices. For example, the ticket might indicate that a progressive controller is to be updated on a Monday. The management host 402 may determine that all EGMs and sign devices in communication with the progressive controller are also affected, and reconfigure the devices accordingly.

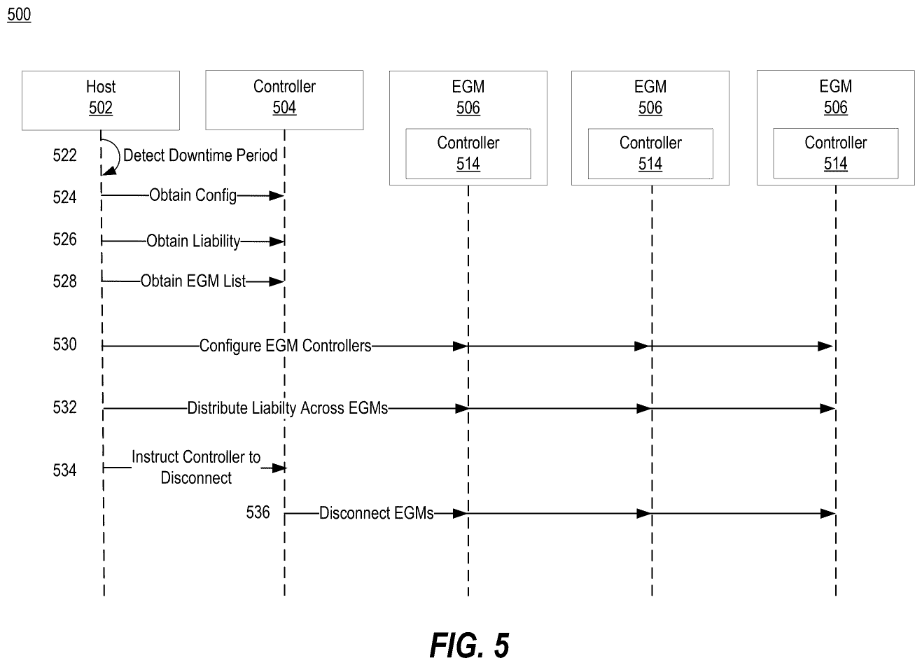

In some examples, a host may configure EGMs in such a way that they no longer need an affected controller, such as by disabling the progressive games or configuring the games to use a standalone embedded progressive controller, i.e., providing a controller for the single EGM itself via the EGM software. In this regard, FIG. 5 illustrates a communication diagram 500 for a host 502, gaming device controller 504, and EGMs 506 to manage the EGMs during a controller downtime event, according to some embodiments.

In this example, the controller 504 may have a progressive liability of $1000 and ten connected EGMs 506. In response to detecting a downtime period for the controller 504 (522), the host 502 may obtain a configuration (524), liability (526), and EGM list (528) from the controller 504. In this example, the host 502 may configure each EGM 506 to have standalone controllers 514 (530), and may move $100 in liability to each EGM 506 (532). The host 502 instructs the controller 504 to disconnect from each EGM 506 (534), and the controller 504 then disconnects each EGM 506 (536).

In some examples, the host 502 may configure each EGM 506 to be in a stand-alone configuration but may not transfer the liability. In this embodiment, the host 502 would return the liability to the controller 504 after the service event.

The host 502 may take any number of compensating actions to mitigate downtime in connected devices, such as move controller functions to a second controller, converting EGMs to stand-alone progressive configurations, converting EGMs to non-progressive configurations, disabling games, themes, paytables denominations, etc., and/or installing and enabling another non-progressive game, etc.

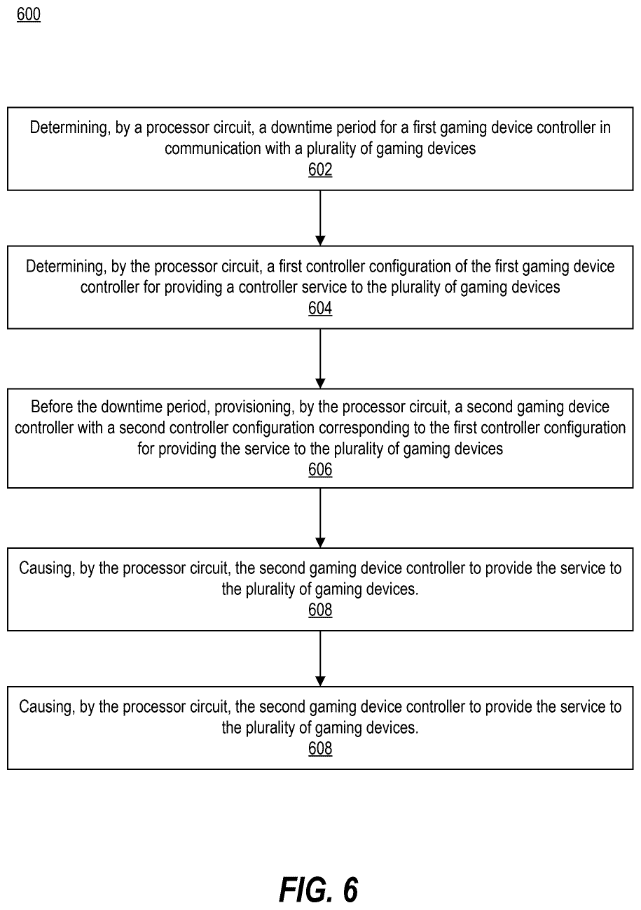

FIG. 6 is a flowchart illustrating operations 600 of operations of systems/methods of providing gaming device management across different controllers, according to some embodiments. The operations 600 may include determining, by a processor circuit, a downtime period for a first gaming device controller in communication with a plurality of gaming devices (Block 602). The operations 600 may further include determining, by the processor circuit, a first controller configuration of the first gaming device controller for providing a controller service to the plurality of gaming devices (Block 604). The operations 600 may further include, before the downtime period, provisioning, by the processor circuit, a second gaming device controller with a second controller configuration corresponding to the first controller configuration for providing the service to the plurality of gaming devices (Block 606). The operations 600 may further include by the processor circuit, the second gaming device controller to provide the service to the plurality of gaming devices (Block 608). The operations 600 may further include stopping, by the processor circuit, provision of the service to the plurality of gaming devices (Block 610).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
determine a downtime period for a first gaming device controller in communication with a plurality of gaming devices;
determine a first controller configuration of the first gaming device controller for providing a controller service to the plurality of gaming devices;
before the downtime period, provision a second gaming device controller with a second controller configuration corresponding to the first controller configuration for providing the service to the plurality of gaming devices; and
cause the second gaming device controller to provide the service to the plurality of gaming devices.

2. The system of claim 1, wherein the instructions further cause the processor circuit to cause the first gaming device controller to stop provision of the service to the plurality of gaming devices.

3. The system of claim 2, wherein instructions further cause the processor circuit to:
determine that the downtime period for the first gaming device controller has ended; and
cause the first gaming device controller to resume provision of the service to the plurality of gaming devices.

4. The system of claim 2, wherein causing the first gaming device controller to stop provision of the service to the plurality of gaming devices occurs before causing the second gaming device controller to provide the service to the plurality of gaming devices.

5. The system of claim 2, wherein causing the first gaming device controller to stop provision of the service to the plurality of gaming devices occurs after causing the second gaming device controller to provide the service to the plurality of gaming devices.

6. The system of claim 1, wherein the instructions further cause the processor circuit to cause the second gaming device controller to stop provision of the service to the plurality of gaming devices.

7. The system of claim 1, wherein the first gaming device controller is a first bank controller,
wherein the plurality of gaming devices are a plurality of Electronic Gaming Machines (EGMs) proximate to the first bank controller, and
wherein the second gaming device controller is a second bank controller.

8. The system of claim 1, wherein the service comprises a progressive wagering game service for provision of a progressive wagering game at the plurality of gaming devices.

9. The system of claim 1, wherein provisioning the second gaming device controller with the second controller configuration further comprises transferring a liability from the first gaming device controller to the second gaming device controller.

10. The system of claim 1, wherein the first gaming device controller is a first Ticket-In/Ticket-Out (TITO) controller,
wherein the plurality of gaming devices are a plurality of Electronic Gaming Machines (EGMs) proximate to the first TITO controller, and
wherein the second gaming device controller is a second TITO controller.

11. The system of claim 1, wherein the second gaming device controller comprises a first gaming device of the plurality of gaming devices.

12. The system of claim 1, wherein second gaming device controller is in communication with a second plurality of gaming devices to provide the service to the second plurality of gaming devices.

13. The system of claim 1, wherein the determination of the downtime period for the first gaming device controller is based on a scheduled downtime period for the first gaming device controller.

14. The system of claim 1, wherein the determination of the downtime period for the first gaming device controller is based on detection of a security breach at the first gaming device controller.

15. The system of claim 1, wherein the determination of the downtime period for the first gaming device controller is based on an operator interaction with the first gaming device controller.

16. A gaming device controller comprising:
a communication interface in communication with a plurality of gaming devices;
a processor circuit; and
a memory comprising machine-readable instructions that, when executed by the processor circuit, cause the processor circuit to:
determine a downtime period for the gaming device;
determine a first controller configuration for providing a controller service to the plurality of gaming devices;
before the downtime period, provision a second gaming device controller with a second controller configuration corresponding to the first controller configuration for providing the service to the plurality of gaming devices; and
instruct the second gaming device controller to provide the service to the plurality of gaming devices.

17. The gaming device controller of claim 14, wherein the instructions further cause the processor circuit to stop provision of the service to the plurality of gaming devices.

18. The gaming device controller of claim 15, wherein instructions further cause the processor circuit to:
determine that the downtime period has ended; and
resume provision of the service to the plurality of gaming devices.

19. A method comprising:
determining, by a processor circuit, a downtime period for a first gaming device controller in communication with a plurality of gaming devices;
determining, by the processor circuit, a first controller configuration of the first gaming device controller for providing a controller service to the plurality of gaming devices;
before the downtime period, provisioning, by the processor circuit, a second gaming device controller with a second controller configuration corresponding to the first controller configuration for providing the service to the plurality of gaming devices; and
causing, by the processor circuit, the second gaming device controller to provide the service to the plurality of gaming devices.

20. The method of claim 19, further comprising stopping, by the processor circuit, provision of the service to the plurality of gaming devices.
